(19) United States
(12) Patent Application Publication
(10) Pub. No.: US 2004/0077793 A1
(43) Pub. Date: Apr. 22, 2004

(54) Polymer composition, process for the preparation of the polymer composition and moulded parts thereof

(76) Inventors: Michiel Jan Dees, Bunde (NL); Jacobus W M Noordermeer, Nieuwstadt (NL)

Correspondence Address: Pillsbury Winthrop, Intellectual Property Group, 1500 Tysons Boulevard, McLean, VA, 22102, US

(21) Appl. No.: 10/433,432

(22) PCT Filed: Dec. 3, 2001
(86) PCT No.: PCT/NL01/00875

(30) Foreign Application Priority Data
Dec. 5, 2000 (NL) 1016799

(51) Int. Cl. C08L 23/00; C08L 23/04

(52) U.S. Cl. 525/240

(57) ABSTRACT

The present invention relates to a polymer composition containing a copolymer, which copolymer contains monomer units of ethylene, an α-olefin and a non-conjugated diene, the polymer composition containing at least copolymer A and copolymer B, which copolymers contain monomer units of ethylene, α-olefin and a non-conjugated diene, the weight-average molecular weight of copolymer A being higher than that of copolymer B and at least copolymer A satisfying the relationship:

Mw/Mn<−0.066.Δδ+a (1)

where

Mw is the weight-average molecular weight of the copolymer,

Mn is the number-average molecular weight of the polymer,

a=4.8

Δδ, expressed in degrees, is the difference between the loss angles at 0.1 rad/s and 100 rad/s, from the quotient of G″/G′, where G′ is the storage modulus is and G″ is the loss modulus, measured by means of mechanic, dynamic spectrometry.

The invention also relates to a polymer composition where at least copolymer A is polymerized with a Ziegler-Natta catalyst containing a transition metal from group 3, 4, 5 or 6, an organometal from group 1, 2, 12 or 13 and a compound according to formula 1, with polymer A and copolymer B being mixed after polymerization.

The invention relates to a polymer composition containing a copolymer, which copolymer contains monomer units of ethylene, an α-olefin and a non-conjugated diene. The invention also relates to a process for the preparation of the polymer composition and moulded parts thereof.

Such a polymer composition is known, for example, from “Rubber Technology Handbook W. Hofmann”; Carl Hanser Verlag (1989), pages 93-100. From this reference a polymer composition is known that contains a copolymer of ethylene, propylene and a non-conjugated diene, hereinafter referred to as EPDM. EPDM is generally mixed further with for example plasticizers, reinforcing fillers and curing agents to obtain an EPDM compound. For processing into a moulded article it is important for the EPDM compound to possess good processing properties, such as for example good flow. For use in a moulded article it is important for the rubber formed from a compound to possess good physical and mechanical properties, for example a high elongation a high tensile strength and a low compression set. One skilled in the art has several options, known from the literature and having a theoretical basis, that can be used to control the processing properties, the physical properties and the mechanical properties. A problem then encountered, however, is that improvement of one of the properties will result in deterioration of one of the other properties.

An EPDM compound, for example, has a good flow if the EPDM has a low weight-average molecular weight, but the rubber formed from this has inferior mechanical properties. Conversely, the rubber formed from the EPDM compound has good mechanical properties if the EPDM as a high weigh average molecular weight, but in that case the EPDM compound has an inferior flow. An EPDM compound further has a good flow if the EPDM has a broad or even bimodal molecular weight distribution or if the EPDM compound contains an EPDM with a high weight-average molecular weight and an EPDM with a low weight-average molecular weight. However, the rubber formed from it again has inferior mechanical properties. There are also other ways to influence the processing properties, the physical properties and the mechanical properties, for example by changing further molecular properties of the EPDM or EPDM compound. In general, however, it continues to be a drawback that if one property is improved another property deteriorates.

The aim of the invention is to provide a polymer composition that contains a copolymer, which copolymer contains monomer units of ethylene, an α-olefin and a non-conjugated diene, which polymer composition has good processing properties as well as good physical and mechanical properties.

Surprisingly, this aim is achieved in that the polymer composition contains at least copolymer A and copolymer B, which copolymers contain monomer units of ethylene, an α-olefin and a non-conjugated diene, the weight-average molecular weight of copolymer A being higher than that of copolymer B and at least copolymer A satisfying the relationship:

Mw/Mn<−0.066.Δδ+a (1)

where

Mw is the weight-average molecular weight of the copolymer,

Mn is the number-average molecular weight of the polymer,

a=4.8

Δδ, expressed in degrees, is the difference between the loss angles, determined at 0.1 rad/s and 100 rad/s, from the quotient of G″/G′, where G′ is the storage modulus and G″ the loss mcdulus, measured using mechanical, dynamic spectrometry.

Although from Keltec, Technical Information Bulletin, March 1998 pages 1-7, an EPDM is known that satisfies formula (1) and that in itself has both fairly good mechanic and fairly good processing properties, it is most surprising that a blend of such an EPDM with an EPDM having a lower weight-average molecular weight should possess both further improved processing properties and further improved mechanical and physical properties, while this is not the case when two random EPDMs are blended.

Yet another advantage of the polymer composition according to the invention is that the polymer composition has very good compounding properties. This is apparent in particular from a good carbon black dispersion achieved during mixing and kneading of the polymer composition to form a compound. It has, surprisingly, been found that blending of copolymer A with copolymer B and carbon black gives rise to a synergistic effect that could certainly not be predicted on the basis of the carbon black dispersions of the individual copolymers A and B. It has moreover been found that less mixing energy is needed for dispersion of carbon black in the polymer composition.

In formula 1 preferably a=4.5, more preferably a=4.3, and more preferably a=4.1.

Δδ from formula 1 and the method for measuring it has been introduced by H. C. Booij, Kautschuk Gummi Kunststoffe 44, 128 (1991).

Copolymers A and B in the composition according to the invention preferably contain monomer units of ethylene and an α-olefin in a molar ratio of between 85/15 (mol/mol) and 20/80 (mol/mol). More preferably the ratio lies between 75/25 and 40/60, even more preferably between 65/35 and 45/55.

The α-olefin for example contains 3-20 C atoms. Preferably the α-olefin contains 3-10 C atoms. Examples of very suitable α-olefins are propylene, butene-1, pentene-1,4-methylpentene-1, hexene-1 and octene-1. Most preferably the α-olefin is propylene.

Copolymer A in the polymer composition according to the invention for example has a weight-average molecular weight (Mw) of between 200,000 and 500,000. Preferably copolymer A has an Mw of between 250,000 and 450,000. Even more preferably copolymer A has an Mw of between 300,000 and 400,000.

The molecular weight distribution (Mw/Mn) of copolymer A may for instance lie between 2 and 10. Preferably Mw/Mn lies between 2 and 4, more preferably between 2.5 and 3.8.

Besides monomer units of ethylene and the α-olefin, copolymer A according to the invention also contains one or more monomer units derived from a polyene. Preferably copolymer A contains 0.1-4 mole % non-conjugated polyene of which preferably 0.01-1 mole % is made up of one or more polyenes that have at least two double carbon-carbon bonds that can be copolymerized using a Ziegler-Natta catalyst, the remainder being made up of one or more polyenes that have one double carbon-carbon bond that can be copolymerized using a Ziegler-Natta catalyst. More preferably copolymer A contains 0.03-0.5 mole % polyene having at least two double carbon-carbon bonds that can be copolymerized using a Ziegler-Natta catalyst. Even more preferably copolymer A contains 0.1-0.3 mole % polyene having at least two double carbon-carbon bonds that can be copolymerized using a Ziegler-Natta catalyst. Examples of non-conjugated polyenes having at least two unsaturated carbon-carbon bonds that can both be copolymerized using a Ziegler-Natta catalyst are 1,4-pentadiene, vinyl norbornene (VNB), 1,5-hexadiene and dicyclopentadiene (DCPD). Copolymer A preferably contains vinyl norbornene as polyene having at least two double carbon-carbon bonds that can be copolymerized using a Ziegler-Natta catalyst.

Preferably copolymer A contains 1.5-2.8 mole % non-conjugated diene having one double carbon-carbon bond that can be copolymerized using a Ziegler-Natta catalyst, more preferably copolymer A contains 1.7-2.4 mole % non-conjugated diene having one double carbon-carbon bond that can be copolymerized using a Ziegler-Natta catalyst. Examples of suitable polyenes having one double bond that can be copolymerized using a Ziegler-Natta catalyst are described in “Ziegler-Natta catalyst and polymerizations” by J. Boor, Jr., Academic Press 1979, chapter 19. Examples are ethylidene norbornene and 1,4-hexadiene. Copolymer A according to the invention preferably contains ethylene norbornene (ENB) as non-conjugated diene having one double carbon-carbon bond that can be copolymerized using a Ziegler-Natta catalyst.

Copolymer B in the polymer composition according to the invention for example has a weight-average molecular weight (Mw) of between 40,000 and 200,000. Preferably copolymer B has an Mw of between 100,000 and 200,000, more preferably of between 125,000 and 175.000.

The molecular weight distribution (Mw/Mn) of copolymer B may for example lie between 2 and 10. Preferably the Mw/Mn lies between 2 and 5, more preferably between 2.5 and 3.8.

Besides monomer units of ethylene and the α-olefin, copolymer B also contains one or more monomer units derived from a polyene. Examples of suitable polyenes are those that contain a double C—C bond in the molecule that can be polymerized using a Ziegler-Natta catalyst in addition to at least another double C—C bond, which is used in subsequent curing of the copolymer. Examples of suitable polyenes are described in “Ziegler-Natta catalyst and polymerizations” by J. Boor, Jr., Academic Press 1979, chapter 19. Examples are ethylidene norbornene and 1,4-hexadiene. Preferably copolymer B contains ethylidene norbornene as non-conjugated polyene. Preferably copolymer B contains 0.5-6 mole % of a non-conjugated polyene. More preferably copolymer B contains between 1.5 and 5 mole % non-conjugated polyene, even more preferably between 2 and 4 mole % non-conjugated polyene.

Besides the above-mentioned polyene copolymer B may for example also contain one or more polyenes that have at least two double carbon-carbon bonds that can be copolymerized using a Ziegler-Natta catalyst. Examples are 1,4-pentadiene, vinyl norbornene (VNB), 1,5-hexadiene and dicyclopentadiene (DCPD). Copolymer B preferably contains vinyl norbornene. For example copolymer B contains 0.02-2 mole % polyene having at least two double carbon-carbon bonds that can be copolymerized using a Ziegler-Natta catalyst. Preferably copolymer B contains 0.06-1 mole % polyene having at least two double carbon-carbon bonds that can be copolymerized using a Ziegler-Natta catalyst. Even more preferably copolymer B contains 0.2-0.6 mole % polyene having at least two double carbon-carbon bonds that can be copolymerized using a Ziegler-Natta catalyst.

Copolymer A and copolymer B preferably have a crystallinity of at most 5% at room temperature and higher temperatures, measured by means of DSC (differential scanning calorimetry).

The invention also relates to a polymer composition in which at least copolymer A has been obtained by polymerization using a Ziegler-Natta catalyst containing a transition metal from group 3, 4, 5 or 6, an organometal from group 1, 2, 12 or 13 and a compound according to formula 2;

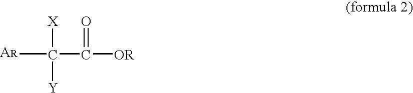

where

X=a chlorine atom

Y=an H atom, a chlorine atom or phenyl

R=H, an alkyl group with 1-30 C atoms or an aromatic group with 6-30 C atoms

Ar=an aromatic group with 6-30 C atoms

The aromatic group (Ar) in the compounds according to formula 2 may be substituted. Examples of such substituents are alkyl, substituted alkyl, alkoxy, halogen, amino, cyanide, nitro, thiol and carboxyl groups. A phenyl or p-tolyl group is preferred.

R is preferably a methyl, ethyl, propyl, isopropyl, butyl, isobutyl, hexyl, octyl, phenyl or tolyl group. More preferably R is an ethyl group.

Y is preferably a chlorine atom or a phenyl group. Preferably use is made of monochlorodiphenyl acetic acid esters or dichlorophenyl acetic acid esters according to formula 2.

The catalyst system used in the synthesis of at least copolymer A comprises a transition metal compound and an organometal compound. In addition, other components may be present, such as Lewis bases. Examples of suitable Lewis bases are: amines, pyridines, ethers and esters.

The transition metal compound contains a metal chosen from the groups 3, 4, 5 or 6 of the Periodic System of the Elements. More than one (1) transition metal compound may be present in the catalyst system. Preference is given to a metal from group 5 of the Periodic System of the Elements; even more preference is given to vanadium. Examples of suitable vanadium compounds are VOCl₃, VCl₄, VCl₃, VCl₃₀.3THF (where THF is a tetrahydrofuran group), V(acac)₃, (where acac is an acetyl acetonate group), VO(acac)₂, Cp₂VCl, (where Cp is a substituted or unsubstituted cyclopentadienyl, indenyl, tetrahydroindenyl or fluorenyl group), VOCl₂OR′ (where R′ is a substituted or unsubstituted alkyl group with 1-20 C atoms).

The organometal compound contains a metal chosen from the groups 1, 2, 12, or 13 of the Periodic System of the Elements. More than one (1) organometal compound may be present in the catalyst system. Preferably at least one of the organometal compounds contains aluminium. This organoaluminium compound preferably satisfies the formula R′₃₋ₙ—AlClₙ, where 0<=n<=2 and R′ is a substituted or unsubstituted alkyl group with 1-20 C atoms. Examples of suitable organoaluminium compounds are triethyl aluminium, triisobutyl aluminium, trioctyl aluminium, methyl aluminoxane, diethylaluminium ethoxide, diisobutyl aluminium chloride, dimethyl aluminium chloride, diethyl aluminium chloride, methyl aluminium dichloride, ethyl aluminium dichloride, isobutyl aluminium dichloride, isobutyl aluminium sesquichloride, ethyl aluminium sesquichloride, etc. Diethyl aluminium chloride and ethyl aluminium sesquichloride are preferred.

The compound according to formula 2 and the other components of the catalyst system can be added to a polymerization reactor both in dissolved condition (preferably a solvent being chosen that is also used in the corresponding liquid phase polymerization) and in a form in which at least one of the components of the catalyst system is applied to a carrier. One skilled in the art is familiar with various techniques that are known in themselves. As carrier material use can for example be made of: silica, alumina, zeolite, MgCl₂, etc.

The polymerization reaction is for example carried out at a temperature between −40 and 200° C., preferably at a temperature between 10 and 80° C. The pressure is for example 3-30 MPa. Preferably the process is carried out continuously, but it can also be carried out semi-continuously or batchwise.

The residence time may vary from a few seconds to a few hours. In general the residence time will be chosen between a few minutes and an hour.

The polymerization may for example be carried out in a solvent that is inert relative to the catalyst system, for example one or more saturated aliphatic hydrocarbons, such as butane, pentane, hexane, heptane, pentamethylheptane or petroleum fractions; aromatic hydrocarbons, for example benzene or toluene, or halogenated aliphatic or aromatic hydrocarbons, for example tetrachloroethylene. Use can be made of such a temperature and pressure that one or more of the monomers used, in particular the α-olefin, for example propylene, is liquid and is present in such a large quantity that it acts as solvent. In that case no other solvent is needed. The polymerization can be carried out both in a polymerization reactor filled with gas and liquid and in a reactor filled entirely with liquid. Copolymer B can also be obtained using the process described above.

Copolymer A and Copolymer B are Blended After Polymerization.

Besides copolymer A and copolymer B the polymer composition may contain a plasticizer, a reinforcing filler, curing agents and other customary rubber compounding additives. Examples of suitable plasticizers are mineral oils, paraffinic oils or naphthenic oils. Examples of reinforcing fillers are carbon black and silica particles. Examples of suitable curing agents are sulphur, sulphur containing compounds and peroxides. Examples of other customary additives are stearic acid and calcium soaps of fatty acids.

Such a polymer composition can be prepared by blending and kneading the copolymers A and B or a blend of the copolymers A and B and the other above-mentioned components, for example in a continuous or a discontinuous kneader such as for example a Banbury mixer.

The present invention also relates to moulded articles manufactured wholly or partly on the basis of the polymer composition according to the invention. In these the copolymers A and/or B may be cured.

The polymer composition according to the invention is suitable for many different applications, for example for the manufacture of profiles with a foam structure, hoses, seal profiles, sealing rings such as for example O-rings and roofing film.

The invention will be elucidated further on the basis of the following examples and comparative experiments, without being limited to these.

To evaluate the processing properties and the mechanical properties of the polymer compositions the following tests were carried out:

The carbon black dispersion was determined, the mixing times at 90 sec and 180 sec being plotted versus volume resistance (VR) according to ASTM D 257; (k Ω.cm)

The compression set (CS) was measured according to ISO 815 type B at 100° C. for 24 hours

The copolymers were characterized on the basis of their Mw and Mn, which were calculated from the molecular weight distribution of the copolymers, which can be determined by means of Gel Permeation Chromatography (GPC) according to the method described below;

The following equipment and experimental conditions were used for this SEC-DV Size Exclusion Chromatography and Differential Viscosimetry:

Equipment:

Waters M150C Gel Permeation Chromatograph (G PC) Chromatography.

Internally heated differential refractive index DRI detector (Waters)

External differential viscometer DV detector (Viscotek) connected via a heated transfer line

0.300 ml injection volume

Columns: 4 TSK GMHxL-HT mixed bed columns

Solvent: 1,2,4-trichlorobenzene stabilized with DBPC

Software: Viscotek TriSEC version 2.7

Calibration: Universal calibration with linear polyethylene (PE) standard molecular weight

0.4-4000 kg/mol

Mark-Houwink PE a: 0.725

Log K: −3.391

Sample Preparation:

Concentration 0.01-0.15 mg/ml

Dissolving for 4 hours at 150° C. under nitrogen

Then filtration using a regenerated cellulose filter at 150° C. This method is described further in great detail in Modern Size-Exclusion Liquid Chromatography by W. W. Yau, J. J. Kirkland, and D. D. Bly, John Wiley & Sons, N.Y. (1979).

Copolymer compositions as used in the examples;

| | | | | | Mole % | Mole % | Mole % |
|---|---|---|---|---|---|---|---|
| | Mw | Mw/Mn | Δδ | a | ethylene | ENB | VNB |
| EPDM1 | 225,000 | 3.0 | 36 | 5.4 | 59.5 | 1.4 | |
| EPDM2 | 175,000 | 2.9 | 36 | 5.3 | 59.5 | 1.4 | |
| EPDM A | 290,000 | 2.9 | 16 | 4.0 | 67.3 | 1.7 | 0.15 |
| EPDM B | 150,000 | 2.7 | 16 | 3.8 | 65.4 | 1.7 | 0.30 |

Comparative Experiment 1

100 parts of EPDM1 together with 80 parts of paraffinic oil, 30 parts of CaCO3 and 70 parts of carbon black were mixed and kneaded for 180 seconds in a Banbury mixer. The compound was then dumped onto a roll at 50° C. upon which 8 parts of a standard curing system were added. Then further mixing took place for 1 minute.

The resulting compound was cured in a press at 180° C. for 12 minutes. The compression set was measured as described above, at 190° C. for 24 hours. The volume resistance (VR) was measured at 90 sec and 180 sec.

The results are presented in Table1.

Comparative Experiment 2

Similar to comparative experiment 1, but instead of 100 parts of EPDM1 a blend of 50 parts of EPDM1 and 50 parts of EPDM2 was used.

Of the cured compound based on EPDM1 and EPDM2 the compression set was measured. The volume resistance was measured at 90 sec and 180 sec.

The results are presented in Table 1.

Comparative Experiment 3

Similar to comparative experiment 1, but instead of 100 parts of EPDM1 use was made of 100 parts of EPDM A. Of the cured compound based on EPDM A the compression set was measured. The volume resistance was measured at 90 sec and 180 sec. The results are presented in Table 1.

### EXAMPLE 1

Similar to comparative experiment 1, but instead of 100 parts of EPDM1 use was made of a blend of 50 parts of EPDM copolymer A and 50 parts of EPDM copolymer B. Of the cured compound based on the EPDM copolymers A and B the compression set was measured. The volume resistance was measured at 90 and 180 sec. The results are presented in Table 1.

TABLE 1

| | CS | VR 90 sec | VR 180 sec |
|---|---|---|---|
| Comparative Experiment 1 | 30 | 12,500 | 12,900 |
| EPDM1 | | | |
| Comparative Experiment 2 | 32 | 4360 | 29,700 |
| EPDM1 + EPDM2 | | | |
| Comparative Experiment 3 | | 26,300 | 39,500 |
| EPDM A | | | |
| Example 1 | 25 | 28,100 | 74,500 |
| EPDM A + EPDM B | | | |

From Table 1 it is evident that the carbon black dispersion of a polymer composition on the basis of two randomly selected EPDM copolymers 1+2 (comparative example 2) after 90 sec mixing is inferior to that of the individual EPDM copolymer 1 (comparative experiment 1). At a longer mixing time, after 180, sec, the carbon black dispersion of the blend of EPDM 1 and EPDM 2 is better. (comparative experiment 2).

The polymer composition on the basis of EPDM copolymer A (comparative example 3) does have a better carbon black dispersion than the EPDM copolymer 1 (comparative example 1) or a blend of EPDM copolymers 1 and 2 (comparative example 2), but when EPDM copolymer A is blended with EPDM copolymer B (example 1) a good carbon black dispersion is obtained already at short mixing times. After a mixing time of 180 sec an excellent carbon black dispersion is obtained. Moreover, the compression set of the blend is also found to improve substantially.

Resuming: if randomly selected EPDM's having different molecular weight, are mixed, than the carbon black dispersion is inferior to that of the single EPDM's after a relatively short mixing cycle.

However, if two EPDM's are mixed, according to the invention, at least the EPDM of the higher molecular weight full fills to the conditions of formula 1, than on the contrary a strongly improved dispersion is obtained, not only after short mixing times, but also after longer mixing times. Moreover a very good value for the compression set is obtained.

1. Polymer composition containing a copolymer, which copolymer contains monomer units of ethylene, an α-olefin and a nor-conjugated diene, characterized in that the polymer composition contains at least copolymer A and copolymer B, which copolymers contain monomer units of ethylene, an α-olefin and a non-conjugated diene, the weight-average molecular weight of copolymer A being higher than that of copolymer B and at least copolymer A satisfying the relationship:
Mw/Mn<−0.066.Δδ+a (1)
where
Mw is the weight-average molecular weight of the copolymer,
Mn is the number-average molecular weight of the polymer,
a=4.8 Δδ, expressed in degrees, is the difference between the loss angles, determined at 0.1 rad/s and 100 rad/s, from the quotient of G″/G′, where G′ is the storage modulus and G″ the loss modulus, measured by means of mechanical, dynamic spectrometry.

2. Polymer composition according to claim 1, characterized in that a=4.5.

3. Polymer composition according to either of claims 1-2, characterized in that a 4.3.

4. Polymer composition according to any one of claims 1-3, characterized in that copolymer A at least contains a non-conjugated diene having two or more C═C bonds that can be polymerized using a Ziegler-Natta catalyst.

5. Polymer composition according to claim 4, characterized in that copolymer A contains vinyl norbornene.

6. Polymer composition according to any one of claims 1-6, characterized in that the amount of vinyl norbornene In copolymer A is 0.01-1 mole %.

7. Polymer composition according to any one of claims 1-6, characterized in that copolymer A has an Mw/Mn that is between 2 and 5.

8. Polymer composition according to claim 1, characterized in that copolymer B has an Mw/Mn that is between 2 and 5.

9. Polymer composition according to any one of claims 1-8, characterized in that copolymer A has a weight average molecular weight of 200,000-500,000 and copolymer B has a weight average molecular weight of 100,000-200,000.

10. Polymer composition according to any one of claims 1-9, characterized in that at least copolymer A has been obtained by polymerization with a Ziegler-Natta catalyst containing a transition metal from group 3, 4, 5 or 6, an organometal from group 1, 2, 12 or 13 and a compound according to formula 2; 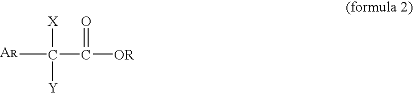
where
X=a chlorine atom
Y=an H atom or a chlorine atom, phenyl
R=H, an alkyl group with 1-30 C atoms or an aromatic group with 6-30 C atoms
Ar an aromatic group with 6-30 C atoms.

11. Polymer composition according to claim 10, characterized in that the transition metal is vanadium.

12. Polymer composition according to claim 10, characterized in that the organometal compound has the formula R′₃₋ₙ—Al—Clₙ, with 0<=n<=2, and where R′ is a substituted or non-substituted alkyl group with 1-20 C atoms.

13. Polymer composition according to claim 10, characterized in that the compound according to formula 2 is chosen from monochlorodiphenyl acetic acid esters or dichlorophenyl acetic acid esters.

14. Moulded article, made wholly or partly from a polymer composition according to any one of claims 1-13.

15. Moulded article according to claim 14, characterized in that copolymer A and/or copolymer B are cured.
